(19) United States
(12) Patent Application Publication
(10) Pub. No.: US 2026/0368124 A1
(43) Pub. Date: Nov. 19, 2026

(54) Chiplet System with Channel Abstraction

(71) Applicant: Tenstorrent USA, Inc., Austin, TX (US)

(72) Inventors: Zhimin Chen, San Jose, CA (US); Lichen Weng, San Jose, CA (US); Samuel Paul Visalli, Allen, TX (US); Wei-han Lien, Saratoga, CA (US)

(21) Appl. No.: 19/679,796

(22) Filed: May 18, 2026

Related U.S. Application Data
(60) Provisional application No. 63/807,880, filed on May 18, 2025.

(51) Int. Cl. G06F 13/42

(52) U.S. Cl. CPC G06F 13/4282; G06F 2213/0002

(57) ABSTRACT

Systems and methods related to chiplets with channel abstraction are disclosed herein. For example, a network of chiplets may comprise chiplets and at least one system-layer architectural inter-chiplet channel associated with a functional domain. The network may also include inter-chiplet communication resources for coupling chiplets according to a different protocols, transport mechanisms, and physical interface types. A chiplet may comprise mappings of the system-layer architectural inter-chiplet channel to respective inter-chiplet communication resources. Abstracting channels to the system layer improves chiplet-system interoperability, bring-up robustness, and runtime adaptability.

### CROSS REFERENCE TO RELATED APPLICATIONS

This application claims the benefit of U.S. Provisional Patent Application No. 63/807,880, filed May 18, 2025, which is incorporated by reference herein in its entirety for all purposes.

### BACKGROUND

The present description relates generally to chiplet-based integrated circuit systems and, more particularly, to communication techniques for system-level functions in networks of chiplets. Chiplets are small, specialized integrated circuits designed to function as individual components in a larger system of which they form a part. Chiplets are then integrated together to form a system, such as a System in Package (SiP), which behaves like a traditional monolithic silicon chip, especially from high-level software perspective. Unlike traditional monolithic integrated circuits where all functions are manufactured together on a single piece of silicon, chiplets may be designed, fabricated, and assembled separately. This approach allows for greater flexibility, improved yields, higher cost efficiency, and shorter time to market. While a chiplet-based SiP offers appealing advantages, it also brings new challenges to the SiP development, especially interoperability among various chiplets. There is a growing demand to standardize the chiplet interfaces and assure interoperability so that the advantages are indeed redeemed.

Partitioning functions across multiple chiplets can increase the complexity of inter-chiplet communication. A chiplet package may include multiple classes of inter-chiplet communication paths. For example, a package may include one or more higher-bandwidth die-to-die paths for data movement and one or more lower-bandwidth or out-of-band paths for initialization, configuration, management, or other control communications. Different chiplets in the package may support different combinations of bus protocols, transport mechanisms, and physical interface types.

Some approaches may dedicate separate communication paths to particular system-level functions. Although dedicated paths can provide isolation, they can also increase routing complexity, pin count, area usage, and power consumption. Other approaches may reuse shared paths for multiple functions, but may require additional logic to determine which communications should use which paths and when. In such systems, hardware and software may need to manage not only the purpose of a communication, but also the currently available lower-layer mechanisms capable of carrying that communication between chiplets.

In addition, a path that is available on one chiplet may not be usable unless a corresponding compatible path is also available on another chiplet. Coordinating protocol support, transport support, and physical interface compatibility across communicating chiplets can therefore add additional complexity to system design and runtime operation. These complications can make bring-up, failover, and runtime path selection more difficult. Accordingly, there is a need for improved chiplet communication techniques.

### SUMMARY

This disclosure relates to chiplet systems with channel abstractions. The present disclosure introduces chiplet communication techniques in which inter-chiplet communication is organized around architectural channels defined at a system layer, rather than being rigidly tied to any single bus protocol, transport mechanism, or physical interface. In disclosed embodiments, an architectural channel represents a system-level communication function associated with a particular functional domain, such as boot, system management, security, interrupt delivery, debug, test, time synchronization, or functional safety. The architectural channel therefore preserves a system meaning independent of the particular lower-layer communication mechanism that is currently used to carry its traffic.

System-level functions such as boot, system management, security, interrupt delivery, debug, test, time synchronization, and functional safety may need to operate across the chiplet package even when not all inter-chiplet communication paths are available at the same time. For example, during bring-up, a higher-speed die-to-die path may not yet be trained or otherwise ready for use, even though certain system-level communications are needed to initialize, configure, or coordinate chiplets. Later, after additional interfaces become available, a different path may be preferred because of bandwidth, latency, isolation, power, or other operating considerations.

In many traditional systems, a given system-level communication function is tied to a fixed lower-layer combination of protocol, transport, and physical interface. Such fixed coupling can complicate coordination between chiplets when interface availability changes, when chiplets support different lower-layer combinations, or when a communication function should move from one type of path to another during operation. These challenges can become more pronounced in heterogeneous or multi-vendor systems, where communication compatibility may need to be maintained across different chiplets without changing the packaged arrangement of the chiplets.

Chiplet systems often need the same system-level communication function to remain available across different stages of operation, even though the lower-layer communication resources available to carry that function may change over time. For example, a lower-bandwidth or out-of-band path may be available early in bring-up, while a higher-bandwidth die-to-die path may become available only after training or other initialization. Instead of treating those different paths as unrelated communication solutions, the disclosed techniques may maintain a persistent architectural channel at the system layer and selectively map that channel to whichever lower-layer implementation is presently suitable.

A channel may be treated as a logical architectural construct for a functional domain, not merely as a wire, port, or virtual lane. The same architectural channel may have multiple candidate mappings, each specifying a respective combination of bus protocol, transport scheme, and physical interface. Logic in the chiplet system may evaluate whether those candidate mappings are available and compatible between communicating chiplets, select an active mapping, and switch the channel to an alternative mapping during runtime when conditions change. In this manner, the lower-layer realization of the channel can change while the architectural identity of the channel remains the same.

In some embodiments, the chiplet system may include mapping-status logic, steering logic, or broader channel abstraction circuitry that monitors the state of candidate communication paths and controls which mapping is currently used for a particular architectural channel. Such logic may be implemented in hardware, software, firmware, or combinations thereof, and may be positioned in or around circuitry that interfaces the system-layer functions of a chiplet to die-to-die communication resources. The switching decision can be based on operating state, interface availability, compatibility between chiplets, completion of high-speed die-to-die training, or other conditions relevant to the active communication environment.

Channels may switch which specific hardware and protocols they use without changing the fixed package topology of the chiplet system. The packaged system may already define which chiplets participate in a given functional domain and which chiplet serves as a primary chiplet for that domain. Runtime reconstruction of the physical arrangement of chiplets may not be required. Instead, a mechanism by which an architectural channel for that domain may be maintained while its lower-layer realization is switched among preexisting and supported communication options. This distinction allows the system to retain a stable architectural organization while still adapting the physical implementation of channel communications at runtime.

These techniques provide several practical benefits. They improve bring-up robustness by allowing system-level channels to start on communication paths that are available early and later transition to preferred higher-performance paths. They improve fault tolerance and failover by allowing traffic associated with an architectural channel to move to an alternative mapping if a selected path becomes unavailable or incompatible. They improve interoperability in heterogeneous chiplet systems by separating the meaning of a system-level communication function from the exact lower-layer implementation used by a given pair of chiplets. They can also reduce the need to dedicate separate fixed physical paths for every system function, because some architectural channels can share interfaces while still preserving channel identity and function-domain semantics.

Accordingly, a chiplet-system communication architecture may incorporate system-layer architectural channels that act as stable functional communication constructs, and may incorporate runtime-selectable mappings to protocol, transport, and interface resources to provide flexible physical realization of those constructs. This combination of persistent system-level channel identity with runtime-selectable lower-layer implementation enables chiplet systems that are more adaptable, more interoperable, and better able to preserve system-level functionality across changing communication conditions.

In specific embodiments of the invention, a network of chiplets is provided. The network comprises: a first chiplet; a second chiplet; a system-layer architectural inter-chiplet channel associated with a functional domain; a first inter-chiplet communication resource for coupling the first chiplet and the second chiplet according to a first protocol, a first transport mechanism, and a first physical interface type; and a second inter-chiplet communication resource for coupling the first chiplet and the second chiplet according to a second protocol, a second transport mechanism, and a second physical interface type. At least one of the first and second protocol, transport mechanism, and physical interface type are different. The first chiplet comprises: a first mapping of the system-layer architectural inter-chiplet channel to the first inter-chiplet communication resource and a second mapping of the system-layer architectural inter-chiplet channel to the second inter-chiplet communication resource.

In specific embodiments of the invention, a chiplet system is provided. The chiplet system comprises a plurality of chiplets, inter-chiplet communication resources coupling the plurality of chiplets, and channel abstraction circuitry configured to define an architectural inter-chiplet channel at a system layer above a protocol layer, a transport layer, and a physical-interface layer, the architectural inter-chiplet channel corresponding to a functional domain of the chiplet system and being identified independently of any particular bus protocol, transport mechanism, or physical interface. The channel abstraction circuitry is also configured to, for the architectural inter-chiplet channel, maintain a first binding specifying a first bus protocol, a first transport mechanism, and a first physical interface of the inter-chiplet communication resources, and a second binding specifying a second bus protocol, a second transport mechanism, and a second physical interface of the inter-chiplet communication resources, the second binding differing from the first binding in at least one of the bus protocol, the transport mechanism, or the physical interface. The channel abstraction circuitry is also configured to select, during runtime, a selected binding from the first binding and the second binding based on an availability condition of the inter-chiplet communication resources, while preserving an identity of the architectural inter-chiplet channel as corresponding to the functional domain. The channel abstraction circuitry is also configured to transmit, using the selected binding, at least one signal corresponding to the functional domain of the architectural inter-chiplet channel.

In specific embodiments of the invention, a network of chiplets is provided. The network of chiplets comprises: a first chiplet; a second chiplet; a first physical interface of the first chiplet and a corresponding first physical interface of the second chiplet that provide a first die-to-die connection between the first chiplet and the second chiplet; and a second physical interface of the first chiplet and a corresponding second physical interface of the second chiplet that provide a second die-to-die connection between the first chiplet and the second chiplet. The first chiplet and the second chiplet support an architectural channel of a system layer associated with a functional domain. The first chiplet comprises a system interface configured to: maintain a first mapping of the architectural channel to a first bus protocol, a first transport scheme, and the first die-to-die connection; maintain a second mapping of the architectural channel to a second bus protocol, a second transport scheme, and the second die-to-die connection; determine, during runtime, that the first mapping is available for communication of traffic of the architectural channel between the first chiplet and the second chiplet; route the traffic of the architectural channel through the first die-to-die connection; determine, during runtime and after routing the traffic through the first die-to-die connection, that the second mapping is available for communication of traffic of the architectural channel between the first chiplet and the second chiplet; and rerouting, during runtime, the traffic of the architectural channel to the second mapping based on the determination that the second mapping is available.

### BRIEF DESCRIPTION OF THE DRAWINGS

The accompanying drawings illustrate various embodiments of systems, methods, and embodiments of various other aspects of the disclosure. A person with ordinary skills in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides an example of a layered model of a chiplet architecture in accordance with specific embodiments of the inventions disclosed herein.

FIG. 2 illustrates an example of a chiplet network with a base chiplet in accordance with specific embodiments of the inventions disclosed herein.

FIG. 3 illustrates examples of chiplet clusters showing use of different channel types within a chiplet network in accordance with specific embodiments of the inventions disclosed herein.

FIG. 4 illustrates an example of a network of chiplets with inter-chiplet communication resources in accordance with specific embodiments of the inventions disclosed herein.

FIG. 5 illustrates a diagram of an example chiplet system including a plurality of chiplets and system-layer channels in accordance with specific embodiments of the inventions disclosed herein.

FIG. 6 illustrates an example network of chiplets with die-to-die connections in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for chiplets with channel abstraction in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

A channel may be treated as a logical architectural construct for a functional domain, not merely as a wire, port, or virtual lane. The same architectural channel may have multiple candidate mappings, each specifying a respective combination of bus protocol, transport scheme, and physical interface. Logic in the chiplet system may evaluate whether those candidate mappings are available and compatible between communicating chiplets, select an active mapping, and switch the channel to an alternative mapping during runtime when conditions change. In this manner, the lower-layer realization of the channel can change while the architectural identity of the channel remains the same.

The systems and methods disclosed herein allow a system-level communication function to be maintained across a network of chiplets while the lower-layer implementation used to carry that communication can be selected, coordinated, and, when appropriate, changed based on availability and compatibility of inter-chiplet communication paths. The systems and methods support such selection and change while preserving the system-level meaning of the communication within a fixed packaged system.

The disclosed techniques provide practical benefits for chiplet-based systems. By defining communication as a system-layer architectural channel that is independent of any one particular protocol, transport mechanism, or physical interface, the system can preserve the identity and purpose of a functional-domain communication path even when its lower-layer implementation changes. This improves bring-up robustness, because a channel can initially use a communication path that is available early, such as a lower-speed or out-of-band path, and later transition to a higher-speed die-to-die path when that path becomes available. The techniques also improve runtime flexibility and fault tolerance, because traffic associated with a given architectural channel can be switched to an alternative mapping when interface availability changes, while the architectural meaning of the channel remains the same. In addition, separating channel identity from lower-layer implementation improves interoperability among heterogeneous chiplets, including chiplets that support different combinations of protocols, transport schemes, and interface types, and can reduce the need for a separate dedicated physical path for every system-level function because multiple architectural channels can share physical resources where appropriate. As a result, the invention can provide chiplet systems that are more adaptable, easier to integrate, more resilient to changing communication conditions, and better able to maintain boot, management, security, interrupt, debug, test, and safety functionality across a fixed packaged topology.

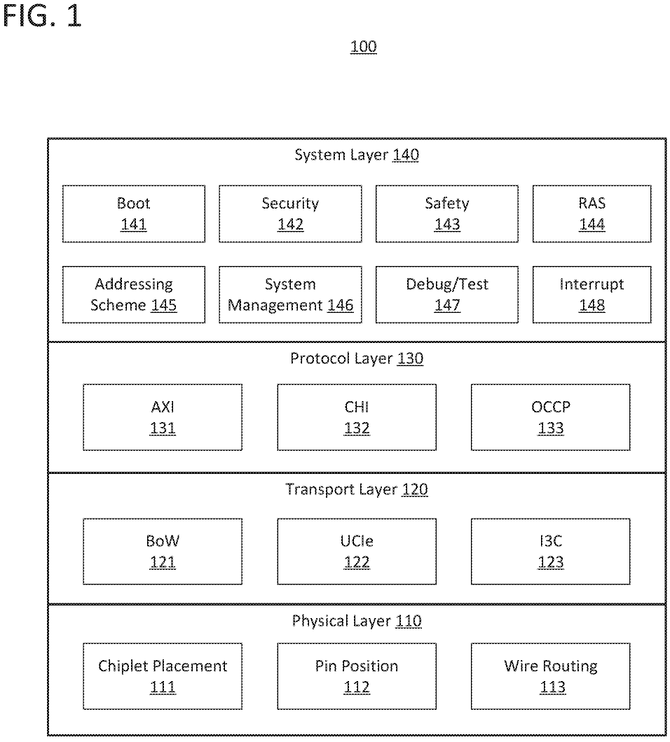

FIG. 1 illustrates layered model 100 of a chiplet architecture in accordance with specific embodiments of the inventions disclosed herein. In the illustrated embodiment, the architecture is organized into physical layer 110, transport layer 120, protocol layer 130, and system layer 140. Layered model 100 is a conceptual representation showing that, in specific embodiments, in order to achieve efficient and reliable chiplet interoperability, chiplet interoperability must be addressed across multiple layers (rather than only at a die-to-die signaling level or other single layer). In specific embodiments, a system of chiplets benefits from addressing inter-chiplet communications across multiple (e.g., all) layers of layered model 100. Layered model 100 may be conceptually similar to the Open Systems Interconnection (OSI) framework that includes a physical layer, a data link layer, a network layer, a transport layer, a session layer, a presentation layer, and an application layer. For example, there may be a separation between lower-level communication mechanisms that physically convey data and higher-level communication constructs that define the meaning and use of the communication.

Physical layer 110 may define physical integration aspects of the chiplet system, such as chiplet placement 111, pin position 112, and wire routing 113. Physical layer 110 may represent package-level and physical-implementation considerations used to physically realize communication among chiplets.

Transport layer 120 may provide mechanisms for transferring data between chiplets. In the illustrated example, transport layer 120 includes Bunch of Wires (BoW) 121, Universal Chip Interconnect Express (UCIe) 122, and Improved Inter-Integrated Circuit (I3C) 123. These transport mechanisms are shown as examples of lower-layer communication technologies by which information may be conveyed among chiplets.

Protocol layer 130 may define mechanisms for interpreting data, packets, messages, transactions, or other communication units and for mapping such communications to local fabrics, higher-level system functions, or buses. In the illustrated example, protocol layer 130 includes AXI 131, CHI 132, and Open Chiplet Configuration Protocol (OCCP) 133. OCCP may be a boot and system management protocol. These protocol examples are illustrative, and other protocol arrangements may be used in other embodiments.

System layer 140 may define system-level functionality distributed across multiple chiplets. In the illustrated example, system layer 140 includes Boot 141, Security 142, Safety 143, Reliability, Availability, Serviceability (RAS) 144, Addressing Scheme 145, System Management 146, Debug/Test 147, and Interrupt 148. These system-layer functions represent architectural functions that enable chiplets to operate together as a coordinated and coherent system.

In some embodiments of the present disclosure, one or more architectural inter-chiplet channels are defined at system layer 140. For example, an architectural channel may correspond to a system-layer function or functional domain such as boot, system management, security, interrupt handling, debug/test, or safety. The architectural channel may thus be maintained as a system-layer construct independently of any particular lower-layer implementation.

A selected implementation of a given architectural channel may be realized through lower layers of the stack, such as the protocol layer 130, transport layer 120, and physical layer 110. Thus, traffic associated with an architectural channel may be mapped to a selected protocol, a selected transport mechanism, and selected physical-layer communication resources. Because the channel is maintained at system layer 140, the identity of the channel may remain unchanged even when its lower-layer realization changes.

Accordingly, FIG. 1 may also illustrate a separation between system-level channel identity and lower-layer communication implementation. In some embodiments, this separation allows a chiplet system to preserve a given architectural channel while selecting among alternative lower-layer mappings based on operating state, availability, or compatibility of communication resources, without changing the system-level meaning of the channel.

The layered arrangement shown in FIG. 1 is illustrative and non-limiting. In various embodiments, one or more layers may be combined, subdivided, omitted, supplemented, or otherwise implemented differently. Likewise, the particular examples shown within each layer are illustrative and do not limit the scope of the disclosed embodiments.

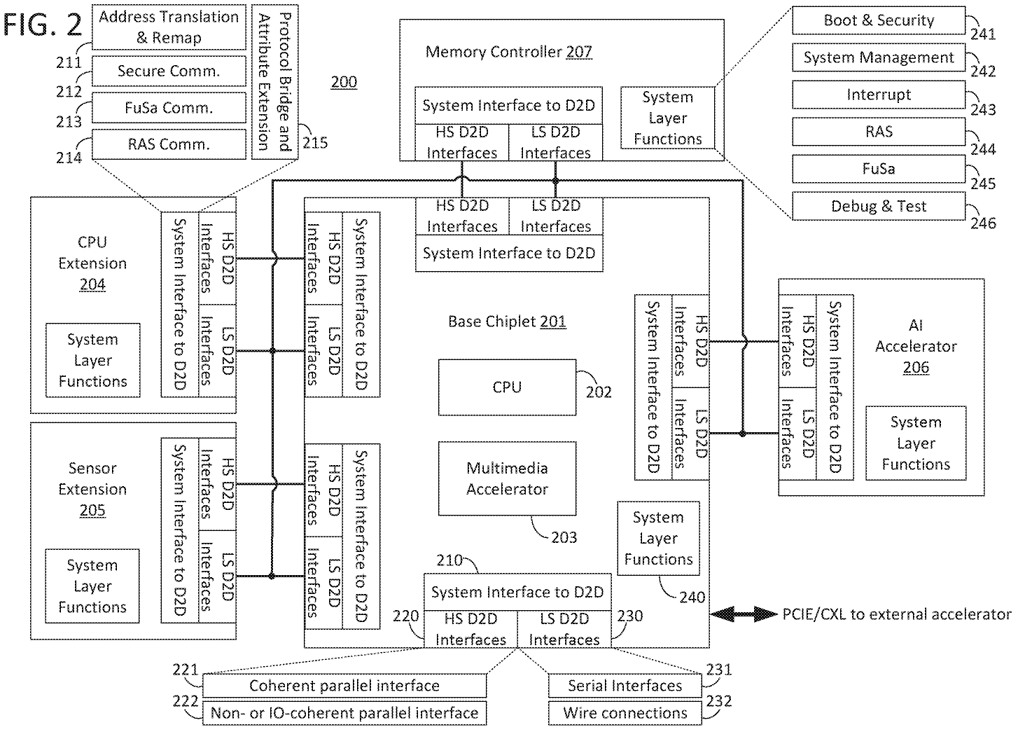

FIG. 2 illustrates an example of chiplet network 200 with base chiplet 201 in accordance with specific embodiments of the inventions disclosed herein. The arrangement of chiplets shown in FIG. 2 is illustrative of an extended chiplet integration in which a base chiplet is coupled to one or more extension chiplets that provide additional compute, memory, sensing, or acceleration functionality. In the illustrated embodiment, chiplet network 200 includes base chiplet 201 having CPU 202 and multimedia accelerator 203. Base chiplet 201 is coupled to additional chiplets, such as CPU extension 204, sensor extension 205, AI accelerator 206, and memory controller 207. In the illustrated example, base chiplet 201 is also shown as being connectable to an external accelerator through a PCIe/CXL connection.

One or more chiplets may include a System Interface to die-to-die (D2D) 210 and corresponding high-speed (HS) D2D Interfaces 220 and low-speed (LS) D2D Interfaces 230. In the illustrated example, the System Interface to D2D 210 may serve as an interface between local functional circuitry of a chiplet and die-to-die communication resources used to communicate with other chiplets. The HS D2D Interfaces 220 may correspond to higher-bandwidth chiplet-to-chiplet communication resources, while the LS D2D Interfaces 230 may correspond to lower-bandwidth, control-oriented, or out-of-band communication resources. By way of example, the HS D2D Interfaces 220 may be associated with a coherent parallel interface 221 or a non-coherent or IO-coherent parallel interface 222, while the LS D2D Interfaces 230 may be associated with serial interfaces 231 or wire connections 232.

In specific embodiments, System Interface to D2D 210 may include or cooperate with a protocol bridge and attribute extension 215. Protocol bridge and attribute extension 215 may support functions such as address translation and remap 211, secure communication 212, functional safety (FuSa) communication 213, and RAS communication 214. In this manner, the System Interface to D2D 210 can provide adaptation between local chiplet functions and one or more selected die-to-die communication mechanisms, while also carrying channel-related attributes or domain-specific information used for inter-chiplet communication.

In the illustrated embodiment, one or more chiplets further include system layer functions 240. Example system layer functions may include Boot and Security 241, System Management 242, Interrupt 243, RAS 244, FuSa 245, and Debug and Test 246. The system-level functionality of a chiplet may be architecturally distinct from the lower-layer communication resources used to carry inter-chiplet traffic.

In some embodiments of the present disclosure, one or more of the functions shown in FIG. 2 may be implemented as respective architectural channels at a system layer. For example, a Boot channel, Security channel, System Management channel, Interrupt channel, RAS-related channel, FuSa channel, or Debug/Test channel may be defined as a system-layer communication construct that is maintained independently of any one particular bus protocol, transport mechanism, or physical interface. The System Interface to D2D of a chiplet may then map traffic of a selected architectural channel to an available and compatible lower-layer implementation, such as an HS D2D interface or an LS D2D interface, depending on operating state, interface availability, or compatibility between communicating chiplets. In this manner, the identity of the architectural channel may be preserved while the physical realization used to carry that channel changes.

For example, in some embodiments, a given architectural channel may initially be carried through an LS D2D Interface during bring-up or other conditions in which a higher-speed chiplet-to-chiplet interface is not yet available, and may later be remapped to an HS D2D Interface after training or establishment of the higher-speed die-to-die connection. Similarly, where multiple chiplets support different combinations of protocols, transport schemes, or interface types, logic in the System Interface to D2D may select among multiple candidate mappings so that traffic for the same architectural channel is steered through a currently available and compatible communication path. A chiplet organization may have system-layer architectural channels that are separable from the lower-layer D2D resources used to implement those channels.

Although FIG. 2 illustrates an extended integration using a base chiplet 201, the disclosed subject matter is not limited to that organization. In other embodiments, a chiplet network may use a centralized chiplet or hub chiplet that primarily provides interconnection among chiplets, rather than serving as a base chiplet to which extension chiplets are attached. In still other embodiments, a chiplet network may use a distributed topology without a hub, in which chiplets communicate through peer-to-peer or otherwise distributed interconnections and each participating chiplet includes corresponding system-interface-to-D2D functionality and system-layer functions. Thus, the particular physical organization of chiplets may vary while still using system-layer architectural channels and lower-layer channel mappings as described herein.

Accordingly, FIG. 2 should be understood as one non-limiting example of a chiplet network in which chiplet functions are partitioned across multiple chiplets, system-layer functions are maintained separately from lower-layer D2D communication resources, and architectural channels may be mapped onto different physical communication resources within the chiplet network. The number, type, and placement of chiplets, as well as the particular organization of the System Interface to D2D, HS D2D Interfaces, LS D2D Interfaces, protocol bridges, and system layer functions, may vary in different embodiments.

In hierarchical system architectures, where chiplets can assume different roles, some chiplets may act as primaries while other chiplets may act as secondaries. A primary chiplet serves as the main control element for a specific functional domain. For each functional domain, there may be a single primary chiplet in a package, while other chiplets operate as secondaries. Different functional domains may have different requirements for the primary chiplet. For example, a boot primary chiplet may have the requirement of booting first, having access to necessary peripheral interfaces, and booting up the rest of the SiP. As another example, the system management primary chiplet may oversee the system management tasks for the whole SiP and may interface to the system software. In specific embodiments, a single chiplet may serve as the primary chiplet across all function domains. In specific embodiments, a SiP integrator may choose to designate different chiplets as the primary for distinct function domains, for example, assigning separate primary chiplets for Security/Boot/Debug/DFT (Design for Test) and for System Management/System Time Management/RAS/FuSa. A chiplet intended to serve as the central controller of the SiP may be designed to support the primary functions of all relevant domains. Chiplets may be designed with secondary capabilities and interfaces to support multi-instantiation and to provide the SiP integrator with the flexibility to designate the appropriate primary for each function domain.

In specific embodiments, chiplets in a package and their connections may form a Directed Acyclic Graph. Each node in the graph may correspond to a chiplet. The edges may indicate physical connections between chiplets. The direction of the edges may not define uni- or bi-directional traffic; instead, the direction may specify the management hierarchy. Following the direction of a directed edge, the graph moves from an upstream chiplet to a downstream chiplet. The upstream chiplet may be at the same or higher management level than the downstream. The topology may include roots, leafs, and non-leafs organized upstream and downstream relative to each other. Chiplets that are upstream of a given chiplet may be chiplets that have a directed path to that chiplet. Chiplets that are downstream of a given chiplet may be chiplets that can be reached from that chiplet via a directed path. The topology root of a directed acyclic graph may also be the primary chiplet in a function domain. A leaf may be an end chiplet with no downstream chiplet. A non-leaf may be an intermediate chiplet with at least one upstream chiplet and one downstream chiplet. The topology view may be domain specific. The primary chiplet of a functional domain may sit at the root of that functional domain’s topology view. Information about the chiplet topology configuration may be provided to software through a data structure. The SiP integrator may provide the data structure. In specific embodiments, topology may be fixed after packaging such that no discovery is required during boot time or run time.

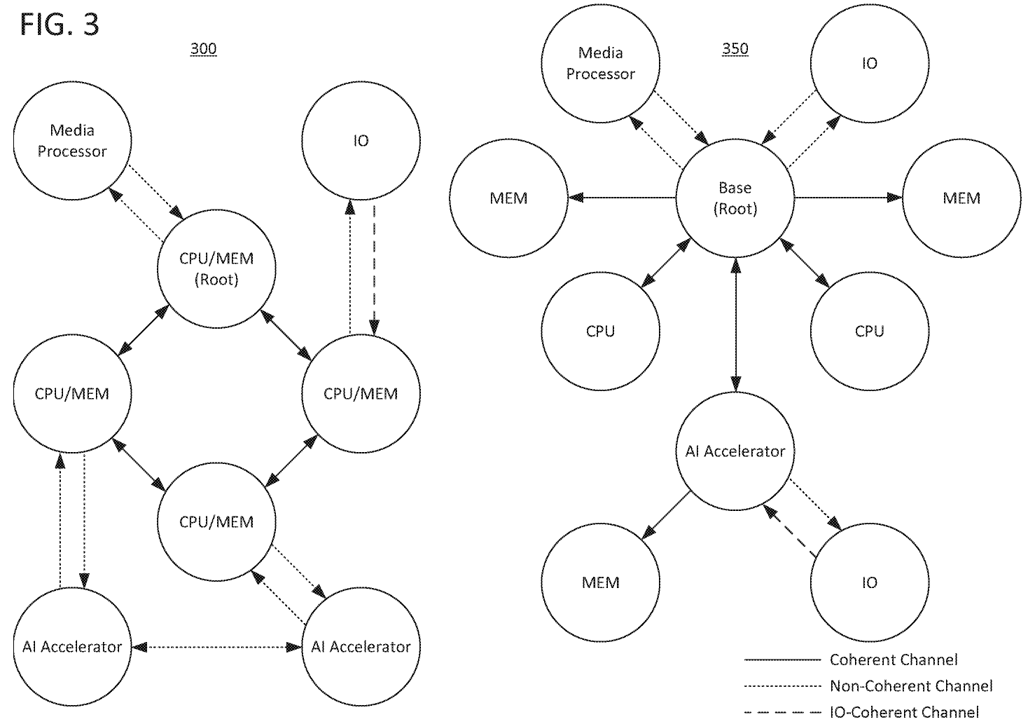

FIG. 3 illustrates example chiplet clusters 300 and 350 showing use of different application-channel types within a chiplet network in accordance with specific embodiments of the inventions disclosed herein. Application channels may connect components such as CPUs, accelerators, and I/O devices to carry out the functional objectives of the SiP. A network of chiplets may include application channels and non-application channels. Application channels may support primary compute elements and high-speed IL/O while non-application channels may be dedicated to specific functions such as boot and system management. A channel may be considered an architectural concept and may not always be equivalent to a physical connection. Some channels may be merged and mapped to a single physical connection, while others may be split across multiple physical connections. Each physical connection may operate with its own bus protocol (e.g.,. AXI, CHI) and transport mechanism (e.g., UCIe, BoW).

Application channels may be organized into three types: coherent channels (indicated by solid lines in FIG. 3), non-coherent channels (indicated by dotted lines), and IO-coherent channels (indicated by dashed lines). Chiplets may communicate using coherent, IO-coherent, and non-coherent application channels, depending on the function of the communicating chiplets and the type of memory or peripheral access to be supported.

A coherent channel may be a communication pathway that ensures memory reads retrieve the most up-to-date copy. It may enable multiple compute chiplets to be interconnected, forming a coherent compute cluster. When a chiplet is expected to form a coherent compute cluster together with other vendors' chiplets, a standardized coherent channel may be used to access the memory hierarchy, including caches and system memory—located on or attached to other chiplets in the cluster. In some cases, such a cluster may be composed entirely of chiplets from the same vendor, allowing the use of vendor-specific interconnect implementations.

A non-coherent channel may be a communication pathway that does not enforce memory coherence between connected components. Unlike coherent channels, it may not guarantee that memory reads will always reflect the most recent writes made by other components. Non-coherent channels may typically be used for peripheral communication or memory access where strict memory consistency across multiple compute elements is not required or guaranteed by software.

An IO-coherent channel may be a communication pathway that allows a source chiplet to participate in a target chiplet’s memory coherence protocol. It may ensure that data accessed by the source chiplet is kept coherent with the target chiplet’s caches and memory. The source chiplet may be able to read and write shared memory without the need for explicit software-managed cache flushes or invalidations.

Cluster 300 illustrates a compute cluster in which a subset of chiplets participate in coherent shared-memory behavior, while other chiplets communicate with the cluster using non-coherent or IO-coherent paths. This allows the chiplet network to support heterogeneous participants without requiring every chiplet in the cluster to participate in the same level of coherence. In cluster 300, a plurality of CPU/MEM chiplets are arranged as a compute-oriented cluster, with one CPU/MEM chiplet acting as a root chiplet for the illustrated cluster view. In some embodiments, coherent channels may couple the root CPU/MEM chiplet with one or more additional CPU/MEM chiplets so that the CPU/MEM chiplets operate as a shared compute cluster with coherent access to memory resources. One or more peripheral or accelerator chiplets, such as a Media Processor, IO chiplet, and AI Accelerator chiplets, may be attached using non-coherent and/or IO-coherent channels according to the communication behavior desired for those chiplets. For example, accelerator or peripheral traffic that does not require full cache coherence may use a non-coherent channel, while an IO-related chiplet may use an IO-coherent channel to access system memory while preserving relevant IO coherency semantics.

Cluster 350 illustrates an example of a heterogeneous cluster that includes a mixture of compute, memory, accelerator, media, and IO chiplets, with different logical channel types used for different communication relationships within the same overall chiplet network. In some embodiments, coherent channels may be used to form a coherent compute domain, while non-coherent or IO-coherent channels may be used for peripheral access, accelerator access, or memory access that does not require full coherence behavior. In cluster 350, a base chiplet is shown at the center of the cluster. In some embodiments, the base chiplet may act as a root or anchor chiplet for a heterogeneous compute cluster. The base chiplet may be coherently coupled to one or more chiplets thereby allowing those chiplets to participate in a coherent heterogeneous compute cluster. In the example of cluster 350, the base chiplet is connected to two CPU chiplets, two MEM chiplets, and an AI accelerator chiplet using coherent channels. Peripheral chiplets, such as media processor chiplets and IO chiplets, may use IO-coherent channels or non-coherent channels to communicate with the heterogeneous compute cluster and system memory. The specific channel used may depend on whether the corresponding traffic is to be treated as coherent shared-memory traffic, non-coherent traffic, or IO-coherent traffic.

A chiplet network can support multiple logical communication relationships over the same physical package. Although the examples of FIG. 3 show application channels, the same chiplet network may support system-layer architectural channels for functions such as boot, address translation, system management, system time management, security, interrupts, RAS, debug, test, or functional safety. In some embodiments of the present disclosure, system-layer architectural channels may be maintained independently of any particular lower-layer implementation, and logic associated with the chiplets may map those architectural channels onto available protocol, transport, and interface resources within clusters such as cluster 300 or cluster 350.

The arrangements shown in clusters 300 and 350 are illustrative and non-limiting. Different embodiments may use different numbers of chiplets, different root chiplets, different types of chiplets, and different mixes of channels. Likewise, a chiplet that acts as a root for one cluster view or functional domain may not act as a root for all channel types or all domains. The chiplet network may simultaneously support channels of different abstraction layers.

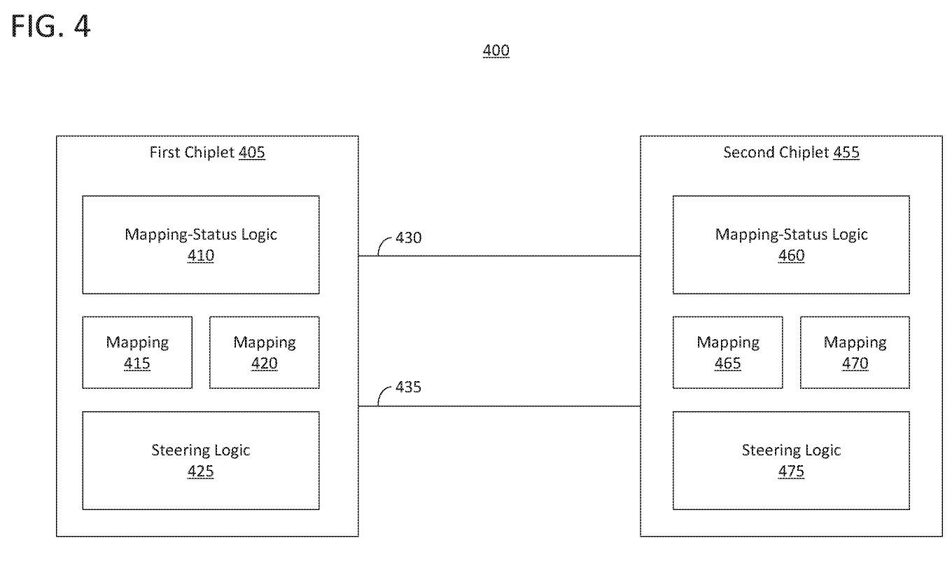

FIG. 4 illustrates an example network 400 of chiplets including first chiplet 405 and second chiplet 455 in accordance with specific embodiments of the inventions disclosed herein. In the illustrated embodiment, the first chiplet 405 and the second chiplet 455 are coupled by first inter-chiplet communication resource 430 and second inter-chiplet communication resource 435. In specific embodiments, first chiplet 405 and second chiplet 455 may support a system-layer architectural inter-chiplet channel associated with a functional domain.

The system-layer architectural inter-chiplet channel may be understood as the architectural channel implemented through alternative mappings 415 and 420. A channel may be an abstracted and logical inter-chiplet communication pathways. A channel may be an architectural concept and may not always be equivalent to a physical connection. Some channels may be merged and mapped to a single physical connection, while others may need to be split across multiple physical connections. Chiplets in connection may map different architectural channels to the same bus protocol, the same transport mechanism, and further the same physical interface. In various embodiments, the system-layer architectural inter-chiplet channel may be a Boot Channel, a System Management Channel, a Security Channel, an Interrupt Channel, a Cross Trigger Channel, a Serial Test Channel, or a Functional Safety Messaging Channel.

An inter-chiplet communication resource may refer to the lower-layer hardware used to physically realize a particular mapping of a system-layer architectural inter-chiplet channel between chiplets. An inter-chiplet communication resource may include, for a given mapping, the circuitry that implements the selected protocol, the circuitry that implements the selected transport mechanism, the circuitry that implements the selected physical interface type at the communicating chiplets, and the corresponding die-to-die connection or path between those chiplets. The inter-chiplet communication resource may not be limited to a single wire, port, or isolated circuit block. Rather, it may be a composite set of hardware elements that collectively carries traffic of the architectural channel according to a selected lower-layer protocol/transport/interface combination. Thus, when a first mapping and a second mapping are maintained for the same architectural channel, a first inter-chiplet communication resource and a second inter-chiplet communication resource may represent respective alternative lower-layer realizations of that same system-layer channel.

In specific embodiments, first inter-chiplet communication resource 430 may correspond to lower-layer hardware used to realize a first mapping of a system-layer architectural inter-chiplet channel, including, for example, corresponding protocol circuitry, transport circuitry, physical-interface circuitry, and an associated die-to-die path between first chiplet 405 and second chiplet 455. Similarly, second inter-chiplet communication resource 435 may correspond to lower-layer hardware used to realize a second mapping of the same system-layer architectural inter-chiplet channel. First and second inter-chiplet communication resources 430 and 435 may differ in protocol, transport mechanism, physical-interface type, D2D paths, or combinations thereof.

First mapping 415 may map the system-layer architectural inter-chiplet channel to first inter-chiplet communication resource 430, and second mapping 420 may map the system-layer architectural inter-chiplet channel to second inter-chiplet communication resource 435. Thus, the same architectural channel may be maintained while alternative lower-layer communication resources are available for carrying traffic of that architectural channel. In specific embodiments, the mappings may be stored in memory. Some architectural channels may be mapped to the same interface and may share the same protocol and transport scheme. Conversely, some channels may be mapped to multiple interfaces; for example, due to situations in which certain interfaces may not be available. In such cases, the channels may switch to alternative interfaces as needed.

First chiplet 405 may include mapping-status logic 410 and steering logic 425. In specific embodiments, mapping-status logic 410 may be configured to determine, during runtime, whether each of first mapping 415 and second mapping 420 is available for communication of traffic of the system-layer architectural inter-chiplet channel between first chiplet 405 and second chiplet 455. Steering logic 425 may be configured to select one of first mapping 415 and second mapping 420 based on a determination of mapping-status logic 410, and to route traffic of the system-layer architectural inter-chiplet channel using the selected mapping.

In some embodiments, the mappings 415 and 420 are known to first chiplet 405 as pre-established associations between a given system-layer architectural inter-chiplet channel and respective alternative lower-layer realizations of that channel. For example, the allowable mappings may be determined from the interfaces implemented by the chiplet, the applicable profile, and package-level configuration information supplied for the assembled system, so that the chiplet knows which combinations of bus protocol, transport mechanism, and physical interface are permitted for the channel. Because the package topology is fixed after packaging, and because connected chiplets are to map a given architectural channel to the same protocol, transport mechanism, and physical interface, first chiplet 405 may maintain local mapping definitions for first mapping 415 and second mapping 420 in configuration storage, control state, or hardwired logic associated with its System Interface. In some embodiments, such mapping definitions may be encoded in a device configuration data structure or other initialization data available to the chiplet. Mapping-status logic 410 therefore may not discover the mappings from scratch during runtime, but instead may evaluate which of the already-known mappings 415 and 420 is currently available and, in some embodiments, compatible, after which steering logic 425 may select the active mapping for traffic of the architectural channel.

In specific embodiments, after traffic has been routed using one of the mappings 415 or 420, the mapping-status logic 410 may determine that the other (previously non-selected) mapping has become available to implement. In response, steering logic 425 may, during runtime, switch routing of the traffic of the system-layer architectural inter-chiplet channel from the previously selected mapping to the other mapping, while maintaining the same system-layer architectural inter-chiplet channel associated with the functional domain. For example, after the high-speed D2D connections are established, boot software can choose to map the Boot Channel to other protocols, transport schemes, and physical interfaces. The architectural identity of the channel may remain unchanged even though the lower-layer implementation used to carry traffic of the channel changes.

In specific embodiments, mapping-status logic 410 may determine whether a given mapping is compatible for communication between first chiplet 405 and second chiplet 455. For example, compatibility may require that first chiplet 405 and second chiplet 455 both support the protocol, transport mechanism, and physical-interface type specified by the mapping. In some embodiments, the compatibility determination may be based on locally stored configuration information or other stored indications of compatibility. Information about the chiplet topology configuration may be provided to software through a standardized data structure. This data structure may be provided by a SiP integrator.

Chiplets in connection may map each corresponding architectural channel to the same bus protocol, the same transport mechanism, and the same physical interface type. In specific embodiments, elements in second chiplet 455 may represent mirrored or counterpart circuitry that supports end-to-end implementation of the selected mapping. In specific embodiments, second chiplet 455 may include mapping-status logic 460, mappings 465 and 470, and steering logic 475. Mapping 415 may correspond to mapping 465 and mapping 420 may correspond to mapping 470. Because the architectural inter-chiplet channel is implemented end-to-end between the chiplets, each chiplet may maintain its own local representation of the alternative mappings for that same channel. Thus, the mappings 465 and 470 of the second chiplet 455 may identify the local protocol, transport, and physical-interface circuitry used at the second chiplet end of the first inter-chiplet communication resource 430 and the second inter-chiplet communication resource 435, while the mapping-status logic 460 may monitor whether those local resources are available and, in some embodiments, compatible with the corresponding resources of the first chiplet 405. The steering logic 475 may configure or select the local transmit-side and/or receive-side path associated with the selected mapping so that traffic of the architectural channel is handled consistently at both ends of the inter-chiplet connection. In this manner, the second chiplet 455 may provide counterpart endpoint logic for the same alternative channel mappings as the first chiplet 405, thereby allowing both chiplets to use the same selected bus protocol, transport mechanism, and physical interface, and to switch together to an alternative mapping when needed, while preserving the identity of the architectural channel. In some embodiments, such logic may be implemented in or in cooperation with a System Interface to D2D of the second chiplet 455. In specific embodiments, one or more of the illustrated elements in the second chiplet 455 may be omitted, combined, or differently arranged.

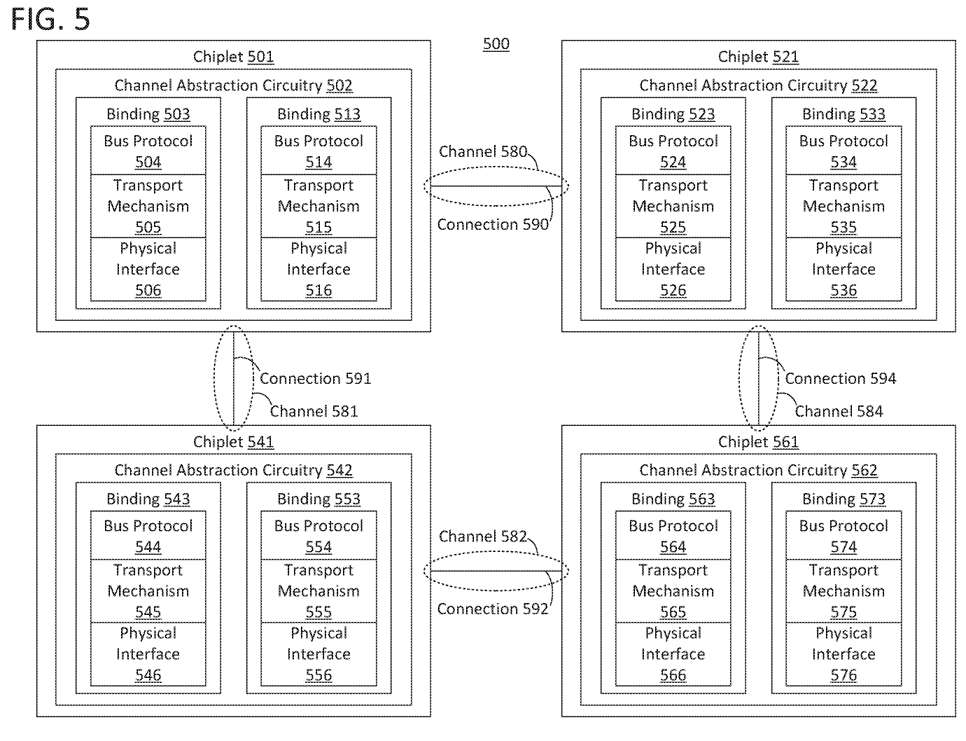

FIG. 5 illustrates a conceptual diagram of an example chiplet system 500 including a plurality of chiplets in accordance with specific embodiments of the inventions disclosed herein. FIG. 5 includes chiplet 501, chiplet 521, chiplet 541, and chiplet 561, connected via channel 580, channel 581, channel 582, and channel 584. Channels 580, 581, 582, and 584 are abstract channels that are implemented using physical connections 590, 591, 592, and 594 respectively. The illustrated arrangement is one example of a multi-chiplet network in which architectural inter-chiplet communication can be defined at a system layer while lower-layer realizations of that communication are selected within the participating chiplets. Each channel may be implemented using the physical connection shown or other physical connections while still being considered the same channel at the system layer. Although four chiplets, four channels, and four physical connections are shown, more or fewer chiplets, more or fewer channels, and more or fewer physical connections may be used in other embodiments.

Each illustrated chiplet houses a respective instance of channel abstraction circuitry, shown as channel abstraction circuitry 502, 522, 542, and 562. In specific embodiments, the channel abstraction circuitry in a given chiplet may define one or more architectural inter-chiplet channels at a system layer above the chiplet’s bus protocol, transport mechanism, and physical interface resources. An architectural inter-chiplet channel may correspond to a functional domain of the chiplet system and may be identified independently of any particular lower-layer implementation. Thus, the architectural identity of a channel can be maintained even though the selected lower-layer realization used to carry signals of that channel may change over time.

As shown in chiplet 501, the channel abstraction circuitry 502 may maintain multiple bindings for an architectural inter-chiplet channel. First binding 503 may specify bus protocol 504, transport mechanism 505, and physical interface 506. Second binding 513 may specify a different bus protocol 514, transport mechanism 515, and physical interface 516. That is, bus protocol 514 may be different than bus protocol 504, transport mechanism 515 may be different than transport mechanism 505, and physical interface 516 may be different than physical interface 506. By having at least one differing aspect, binding 513 may be different than binding 503. Similarly, chiplets 521, 541, and 561 may maintain first bindings 523, 543, and 563 with bus protocols 524, 544, and 564; transport mechanisms 525, 545, and 565; and physical interfaces 526, 546, and 566 respectively; and may maintain second bindings 533, 553, and 573 represented by bus protocols 534, 554, and 574; transport mechanisms 535, 555, and 575; and physical interfaces 536, 556, and 576 respectively. Each chiplet may locally store or otherwise maintain alternative lower-layer implementations by which a given architectural channel can be carried.

Bindings as described herein may be understood as defining alternative associations between an architectural inter-chiplet channel and the lower-layer communication resources used to implement that channel. In some embodiments, a first binding may correspond to a first class of inter-chiplet communication resource, such as a lower-speed or out-of-band path, while a second binding may correspond to a second class of inter-chiplet communication resource, such as a higher-speed die-to-die path. In other embodiments, the difference between the bindings may be in the selected bus protocol, the selected transport mechanism, the selected physical interface, or any combination thereof. Because the architectural channel is maintained at the system layer, the same channel may be transmitted using either binding while preserving the channel’s functional-domain identity.

In operation, the channel abstraction circuitry of a chiplet may select, during runtime, a selected binding from its available bindings based on an availability condition of the inter-chiplet communication resources. The availability condition may be derived from an operating state of the chiplet system, such as a boot stage, link-training state, power state, reset state, or whether a high-speed die-to-die connection has been established. Once a binding is selected, the channel abstraction circuitry may cause one or more signals corresponding to the functional domain of the architectural channel to be transmitted using the selected binding. Such signals may include, by way of example, boot-related signals, system-management signals, security-related signals, interrupt-related signals, cross-trigger signals, serial-test signals, or functional-safety messaging signals.

A chiplet system may support a plurality of architectural inter-chiplet channels. For example, channel 580, channel 581, channel 582, and channel 584 may correspond to different functional domains, or some of them may correspond to different instances of a same class of system-layer channel in different parts of the network. For ease of illustration, FIG. 5 shows two bindings in each instance of channel abstraction circuitry. In some embodiments, however, the circuitry may maintain respective first and second (or more) bindings on a per-channel basis for multiple architectural channels, such that each channel supported by a chiplet can be independently identified at the system layer and independently associated with its own alternative lower-layer realizations.

In some embodiments, at least two architectural inter-chiplet channels may share a common physical interface. For example, in chiplet 501, both channel 580 and channel 581 may, in some operating states, use the physical interface 506 of the first binding 503, while in chiplet 521, two different channels may share physical interface 526. Likewise, channels may share a common first physical interface within a chiplet while still remaining logically distinct at the system layer. This allows multiple architectural channels to coexist in the same chiplet system without requiring a unique dedicated physical interface for every system-layer function.

The system-layer channels represented in FIG. 5 may correspond to any suitable functional domains of the chiplet system. In specific embodiments, one or more of the illustrated channels may comprise a Boot Channel, System Management Channel, Security Channel, Interrupt Channel, Cross Trigger Channel, Serial Test Channel, or Functional Safety Messaging Channel. A generalized channel-abstraction structure that may be applicable to multiple different classes of architectural channels, even though the lower-layer protocol, transport, and physical-interface combinations used by those channels may differ.

In some embodiments, the channel abstraction circuitry may include hardware control logic configured to monitor the availability condition of the inter-chiplet communication resources and to switch an architectural inter-chiplet channel from one binding to another binding when appropriate. Such hardware control logic may include, for example, a state machine. The state machine may be in a system interface of one or more chiplets. The state machine may automatically switch from a selected binding to another binding based on a hardware-detected change in availability of a physical interface, such as detection that a high-speed die-to-die connection has become established and is ready for use. In this way, switching between bindings may occur automatically at runtime without requiring the architectural identity of the channel to change.

In specific embodiments, the availability condition may be derived from an operation state of the chiplet system. The operation state may indicate, for example, whether the system is in an initial boot stage, whether power and clock have been supplied, whether reset or initialization has completed, whether a high-speed D2D connection has been trained or established, whether only a low-speed or out-of-band path is presently usable, or whether coherent or non-coherent transport resources are currently active in the chiplet system. Thus, in an earlier operation state, a first binding may be treated as available because it uses a low-speed or out-of-band path that is ready for use during bring-up, while a second binding that depends on a high-speed D2D connection may be treated as unavailable until link training or other initialization has completed. After the operation state changes, the availability condition may likewise change, permitting the channel abstraction circuitry to select or switch to a different binding for the same architectural channel. The availability condition may reflect the current stage or mode of operation of the chiplet system, allowing the system to preserve the identity of the system-layer architectural channel while adapting its lower-layer protocol, transport mechanism, and physical-interface realization to the communication resources that are usable in that state.

In specific embodiments, switching between bindings may be performed in response to a software command. For example, software executing on or for one or more chiplets may determine that a different binding should be used for a given architectural inter-chiplet channel and may command the channel abstraction circuitry to switch from a currently selected binding to another binding. Hardware-based control and software-based control may also be combined, such as where hardware monitors interface readiness and software authorizes or initiates the transition to a newly available binding. Accordingly, a chiplet system may include automatic hardware-driven switching, software-directed switching, or hybrid switching arrangements.

Although FIG. 5 depicts one instance of channel abstraction circuitry per chiplet, the number and arrangement of such circuitry may vary. In some embodiments, each chiplet in the plurality of chiplets houses a corresponding instance of channel abstraction circuitry, and the first physical interface and second physical interface referenced by the bindings of a given instance refer to physical interfaces of that same chiplet. In other embodiments, portions of the circuitry may be distributed across multiple local blocks within a chiplet, or some functions may be combined. A chiplet system may preserve system-layer channel identity while maintaining and selecting among alternative lower-layer bindings for communication among multiple chiplets.

In some embodiments, chiplets that are in communication with one another may map each architectural channel to the same bus protocol, the same transport mechanism, and the same physical interface at the two ends of the connection. The selected mapping need not be fixed for all channels or for all operating conditions. Rather, for at least some channels, the mapping may vary according to availability of the underlying physical interfaces or transport paths. For example, a coherent channel may be carried using a coherent protocol and coherent transport when the coherent transport path is available, and the coherent channel may be unavailable when the coherent transport path is unavailable. Similarly, non-coherent and IO-coherent channels may be carried using a non-coherent protocol and non-coherent transport when the non-coherent transport path is available, and those channels may be unavailable when the non-coherent transport path is unavailable.

During boot and other management-oriented operations, different mappings may be used depending on whether a high-speed D2D connection has been established. In some embodiments, OCCP may define a protocol by which an upstream chiplet, such as a Boot Primary chiplet, initiates transactions to downstream chiplets, and by which a downstream chiplet notifies its immediate upstream self-boot chiplet when a boot report is available. During an initial boot stage, the Boot Channel may use OCCP as the bus protocol and BOOT_TRN as the transport scheme. BOOT_TRN may be dependent on the chiplet configuration. After the high-speed D2D connections are established, boot software may remap the Boot Channel to other protocols, transport schemes, and physical interfaces. Likewise, when a high-speed D2D connection is unavailable, the System Management Channel may use OCCP as the protocol and SM_TRN as the transport scheme. SM_TRN may be dependent on the chiplet configuration. When the high-speed D2D connection becomes available, the System Management Channel may, by default, use the high-speed D2D connection with a non-coherent protocol as the bus protocol and a non-coherent transport scheme as the transport scheme, while still retaining the ability to use the SM_TRN path. The System Time Management Channel may use the Open Chiplet Time Synchronization (OCTS) scheme as both protocol and transport. Similarly, when the high-speed D2D connection is unavailable, the Security Channel may use OCCP as the protocol and BOOT_TRN as the transport scheme; when the high-speed D2D connection is available, the Security Channel may, by default, use the high-speed D2D connection with a non-coherent protocol and a non-coherent transport scheme, while still being able to use the BOOT_TRN path.

In some embodiments, the Interrupt Channel may also be selected according to availability of underlying channel types. When a non-coherent channel or an IO-coherent channel exists, the Interrupt Channel may use a non-coherent protocol as the bus protocol and a non-coherent transport scheme as the transport scheme. When only a coherent channel exists, the Interrupt Channel may instead use a coherent protocol as the bus protocol and a coherent transport scheme as the transport scheme. If neither the non-coherent transport path nor the coherent transport path is available, the Interrupt Channel may itself be unavailable. The Address Translation Channel may accompany the applicable memory-access channel, such as a coherent channel, an IO-coherent channel, or a non-coherent channel. In such embodiments, the corresponding coherent and non-coherent protocols may support memory access traffic, address translation requests, and page-request messages.

Additional channels may likewise be assigned respective protocol and transport combinations. For example, the Cross Trigger Channel may use the Open Chiplet Cross Triggering (OCCT) scheme for both protocol and transport. The Serial Test Channel may use IEEE 1838 as the protocol and JTAG as the transport scheme. A safety interrupt channel may use two wires to deliver two level-based interrupts, such as a fatal interrupt and a non-fatal interrupt. A safety message channel may use the Open Chiplet Safety Protocol (OCSP) as the protocol and may use FUSA_TRN as the corresponding transport scheme. FUSA_TRN may be dependent on the chiplet configuration. A chiplet system may preserve the identity of an architectural channel while selecting an appropriate lower-layer protocol, transport scheme, and physical interface for that channel based on the capabilities and current operating state of the communicating chiplets.

The physical communication interfaces of a chiplet may depend on the chiplet role (primary vs. secondary), location in the topology (root, leaf, or somewhere in the middle), special application needs (FuSa, RAS, etc.), cache coherency requirements, and bandwidth requirements. A Non-Fully-Coherent Interface may be a high-bandwidth interface that can be used for non-coherent or IO-coherent memory access, interrupt delivery, configuration, etc. A Coherent Interface may be a high-bandwidth interface for fully coherent memory access. An Out-of-Band (OOB) Boot Interface may be a low-bandwidth, highly available interface for Boot and Security. It may be out-of-band relative to the high-bandwidth D2D interfaces. An OOB Management Interface may be a low-bandwidth, highly available interface for System Management. It may be out-of-band relative to the high-bandwidth D2D interfaces. A Timer Sync Interface may be a dedicated interface for system timer synchronization. A Cross Trigger Interface may be a dedicated interface for cross triggering. A Serial Test Interface may be a test interface for in-package test network. A wired Interrupts Interface may be a dedicated interface for wired interrupts, serving Functional Safety and System Management. A FuSa Message Interface may be a dedicated messaging interface for Functional Safety. Certain architectural channels may be mapped to the same interface and thus may share the same protocol and transport scheme. Conversely, some channels may be mapped to multiple interfaces, for example because certain interfaces may not always be available. In such cases, these channels may switch to alternative interfaces as needed.

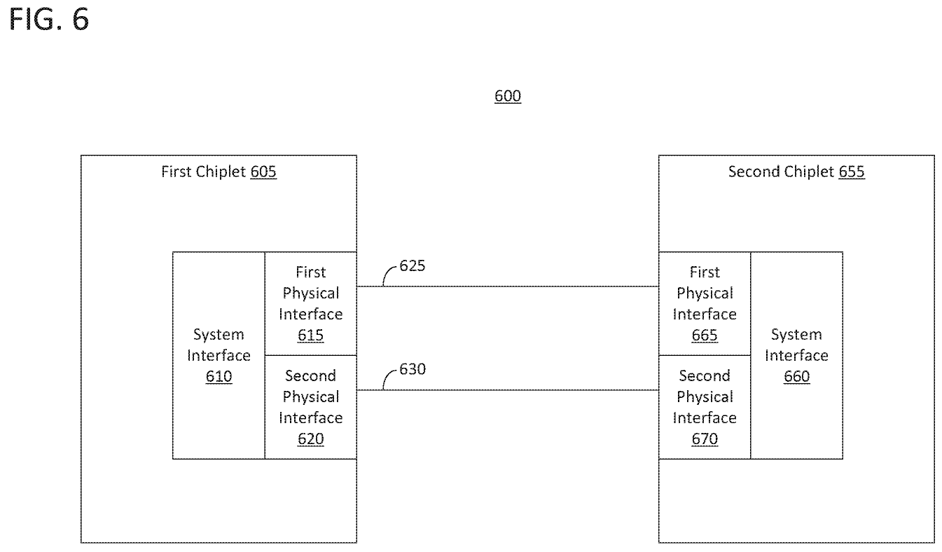

FIG. 6 illustrates an example network 600 of chiplets including first chiplet 605 and second chiplet 655 in accordance with specific embodiments of the inventions disclosed herein. In the illustrated embodiment, first chiplet 605 includes system interface 610, first physical interface 615, and second physical interface 620. Second chiplet 655 includes system interface 660, first physical interface 665, and second physical interface 670. First physical interface 615 of first chiplet 605 and corresponding first physical interface 665 of second chiplet 655 may provide first D2D connection 625 between the chiplets. Second physical interface 620 of first chiplet 605 and the corresponding second physical interface 670 of second chiplet 655 may provide second D2D connection 630 between the chiplets. System interfaces 610 and 660 may each be a system interface to D2D. A system-layer architectural channel may be selectively implemented through different protocol/transport/interface combinations over first D2D connection 625 and second D2D connection 630.

In specific embodiments, first chiplet 605 and second chiplet 655 may support an architectural channel of a system layer associated with a functional domain. The architectural channel may correspond, for example, to a Boot Channel, a System Management Channel, a Security Channel, an Interrupt Channel, a Cross Trigger Channel, a Serial Test Channel, a Functional Safety Messaging Channel, or another system-layer channel. The architectural channel itself may be understood as the system-layer communication construct whose traffic is selectively carried over either D2D connection 625 or D2D connection 630. In this manner, the architectural channel may remain the same channel for the functional domain even though the lower-layer realization used to carry its traffic changes over time.

In some embodiments, system interface 610 of first chiplet 605 may be configured to maintain a first mapping of the architectural channel to a first bus protocol, a first transport scheme, and the first D2D connection 625, and to maintain a second mapping of the architectural channel to a second bus protocol, a second transport scheme, and second D2D connection 630. Thus, system interface 610 may store, define, or otherwise maintain multiple candidate lower-layer realizations for the same architectural channel. The first mapping and the second mapping may differ in bus protocol, transport scheme, physical interface usage, or combinations thereof. In some embodiments, system interface 610 may include mapping-selection logic, configuration state, or other control circuitry that identifies which mapping is currently active for carrying traffic of the architectural channel. In specific embodiments, the mapping-selection logic, configuration state, and other control circuitry may be separate from system interface 610.

In specific embodiments, system interface 610 may determine, during runtime, that the first mapping is available for communication of traffic of the architectural channel between the first chiplet 605 and the second chiplet 655. In specific embodiments, system interface 610 may determine that the second mapping is unavailable. For example, the connection of the second mapping may not be established. Accordingly, system interface 610 may route the traffic of the architectural channel through the first D2D connection 625.

At a later time, and after routing some of the traffic using the first mapping, system interface 610 may determine that the second mapping is available for communication of traffic of the architectural channel between the chiplets. For example, the connection of the second mapping may be established, making the second mapping available. System interface 610 may reroute, during runtime, the traffic of the architectural channel to the second mapping through the second D2D connection 630. In specific embodiments, rerouting to the second mapping may occur based on the second mapping becoming available, and may not require that the first mapping has become unavailable. In specific embodiments, the first mapping may become unavailable.

In specific embodiments, availability of the second mapping may be determined based on an operating condition of the chiplet network, such as establishment, training, initialization, powering, or enabling of second D2D connection 630 or one or both of the second physical interfaces 620 and 670. In specific embodiments, a first communication path may be used at an earlier stage of operation and a second communication path may be used at a later stage of operation after additional communication resources become available. Specific embodiments may support additional switching events, including switching back to the first mapping or switching among more than two mappings.

The rerouting described with respect to FIG. 6 need not be limited to a single one-way transition from the first mapping to the second mapping. Rather, after traffic of the architectural channel has been rerouted to the second mapping through second D2D connection 630, system interface 610 may continue to monitor the then-current operating conditions of the chiplet network, including availability of first D2D connection 625, availability of second D2D connection 630, and, in some embodiments, compatibility of the corresponding mappings between first chiplet 605 and second chiplet 655. If the first mapping later again becomes preferred, for example because the first mapping becomes available after a temporary interruption, because the second mapping becomes unavailable, or because a control policy indicates that the first mapping is more appropriate for a current operating state, system interface 610 may switch traffic of the same architectural channel back to the first mapping while preserving the identity of the architectural channel at the system layer.

In specific embodiments, first chiplet 605 may maintain more than two candidate mappings for the same architectural channel, for example by supporting three or more combinations of protocol, transport scheme, and physical-interface resources. In such embodiments, system interface 610 may select among those multiple mappings according to availability, compatibility, operating state, performance considerations, power considerations, software control, hardware-detected interface state, or other selection criteria, and may switch traffic of the architectural channel among three or more alternative lower-layer realizations over time. Accordingly, the disclosed techniques may support repeated switching events, return switching to a previously used mapping, and switching among more than two mappings, while maintaining a persistent system-layer architectural channel associated with the corresponding functional domain.

System interface 660 in second chiplet 655 may represent counterpart logic at the second chiplet end of the connection. In some embodiments, system interface 660 may maintain corresponding local mapping information for first physical interface 665 and second physical interface 670, and may coordinate with first chiplet 605 so that both chiplets use a compatible protocol, transport scheme, and physical interface arrangement for whichever mapping is active. Second chiplet 655 can include corresponding endpoint logic for receiving traffic on first D2D connection 625 and later on second D2D connection 630.

In specific embodiments, the architectural channel may be a Boot Channel, the first bus protocol may be Open Chiplet Configuration Protocol (OCCP), and the second D2D connection 630 may be a high-speed D2D connection. In such embodiments, the first mapping may be used during an earlier boot stage, for example before the high-speed connection is available, and the system interface 610 may later reroute boot traffic to the second mapping after the high-speed connection has become available.

In specific embodiments, the architectural channel may be a System Management Channel, the first bus protocol may be OCCP, the second bus protocol may be a noncoherent protocol, and the second D2D connection 630 may be a high-speed D2D connection. In such embodiments, the first mapping may correspond to a lower-speed or out-of-band system-management path, while the second mapping may correspond to a higher-speed noncoherent path used once the high-speed connection is available.

In specific embodiments, the architectural channel may be a Security Channel, the first bus protocol may be OCCP, the second bus protocol may be a noncoherent protocol, and the second D2D connection 630 may be a high-speed D2D connection. In such embodiments, security-related traffic may initially use a first mapping associated with first D2D connection 625 and may later be rerouted to the second mapping associated with the high-speed second D2D connection 630. The same general runtime rerouting structure can be used for multiple different system-layer channels, including boot, system management, and security, while preserving the architectural identity of the channel involved.

A system-layer architectural channel can be carried first by one mapping and later by another mapping, with rerouting performed during runtime as additional communication resources become available. The arrangement shown in FIG. 6 is illustrative and non-limiting. The placement, number, and type of system interfaces and physical interfaces may vary, and one or more functions shown as separate blocks may be combined. Likewise, the first D2D connection 625 and the second D2D connection 630 may be implemented using different physical-interface types, different transport schemes, different bus protocols, or combinations thereof. For example, multiple mappings may use the same bus protocols and transport schemes but different physical interfaces.

While the specification has been described in detail with respect to specific embodiments of the invention, it will be appreciated that those skilled in the art, upon attaining an understanding of the foregoing, may readily conceive of alterations to, variations of, and equivalents to these embodiments. A processor may operate with a computer-readable non-transitory medium storing instructions. The computer-readable medium may be memory within a personal user device or a network accessible memory. Although examples in the disclosure were generally directed to chiplet systems, other multi-die integrated circuit systems may be used. These and other modifications and variations to the present invention may be practiced by those skilled in the art, without departing from the scope of the present invention, which is more particularly set forth in the appended claims.

What is claimed is:

1. A network of chiplets comprising:
a first chiplet;
a second chiplet;
a system-layer architectural inter-chiplet channel associated with a functional domain;
a first inter-chiplet communication resource for coupling the first chiplet and the second chiplet according to a first protocol, a first transport mechanism, and a first physical interface type; and
a second inter-chiplet communication resource for coupling the first chiplet and the second chiplet according to a second protocol, a second transport mechanism, and a second physical interface type, wherein at least one of the first and second protocol, transport mechanism, and physical interface type are different;
wherein the first chiplet comprises:
a first mapping of the system-layer architectural inter-chiplet channel to the first inter-chiplet communication resource; and
a second mapping of the system-layer architectural inter-chiplet channel to the second inter-chiplet communication resource.

2. The network of claim 1, wherein the first chiplet further comprises:
mapping-status logic configured to determine, during runtime, whether each of the first mapping and the second mapping is available for communication of traffic of the system-layer architectural inter-chiplet channel between the first chiplet and the second chiplet; and
steering logic configured to select one of the first mapping and the second mapping based on a determination of the mapping-status logic, to route the traffic of the system-layer architectural inter-chiplet channel using the selected mapping.

3. The network of claim 2, wherein:
the mapping-status logic is further configured to, after the traffic is routed using the selected mapping, determine that the non-selected other mapping of the first mapping and the second mapping is available; and
the steering logic is further configured to, during runtime and based on the determination that the other mapping is available, route the traffic of the system-layer architectural inter-chiplet channel using the other mapping while maintaining the system-layer architectural inter-chiplet channel.

4. The network of claim 2, wherein the mapping-status logic is further configured to determine, during runtime, whether each of the first mapping and the second mapping is compatible for communication of traffic of the system-layer architectural inter-chiplet channel between the first chiplet and the second chiplet, compatibility requiring that the first chiplet and the second chiplet both support the protocol, transport mechanism, and physical interface type specified by the respective mapping.

5. The network of claim 4, wherein determining whether each of the first mapping and the second mapping is compatible for the communication of the traffic of the system-layer architectural inter-chiplet channel comprises reading a stored indication of compatibility.

6. The network of claim 1, wherein the system-layer architectural inter-chiplet channel comprises one of a Boot Channel, a System Management Channel, a Security Channel, an Interrupt Channel, a Cross Trigger Channel, a Serial Test Channel, and a Functional Safety Messaging Channel.

7. A chiplet system comprising:
a plurality of chiplets;
inter-chiplet communication resources coupling the plurality of chiplets; and
channel abstraction circuitry configured to:
define an architectural inter-chiplet channel at a system layer above a protocol layer, a transport layer, and a physical-interface layer, the architectural inter-chiplet channel corresponding to a functional domain of the chiplet system and being identified independently of any particular bus protocol, transport mechanism, or physical interface;
for the architectural inter-chiplet channel, maintain a first binding specifying a first bus protocol, a first transport mechanism, and a first physical interface of the inter-chiplet communication resources, and a second binding specifying a second bus protocol, a second transport mechanism, and a second physical interface of the inter-chiplet communication resources, the second binding differing from the first binding in at least one of the bus protocol, the transport mechanism, or the physical interface;
select, during runtime, a selected binding from the first binding and the second binding based on an availability condition of the inter-chiplet communication resources, while preserving an identity of the architectural inter-chiplet channel as corresponding to the functional domain; and
transmit, using the selected binding, at least one signal corresponding to the functional domain of the architectural inter-chiplet channel.

8. The chiplet system of claim 7, wherein the channel abstraction circuitry is configured to:
define a plurality of architectural inter-chiplet channels at the system layer, each architectural inter-chiplet channel corresponding to a respective functional domain of the chiplet system and being identified independently of any particular bus protocol, transport mechanism, or physical interface; and
for each architectural inter-chiplet channel of the plurality of architectural inter-chiplet channels, maintain a respective first binding specifying a respective first bus protocol, a respective first transport mechanism, and a respective first physical interface of the inter-chiplet communication resources, and a respective second binding specifying a respective second bus protocol, a respective second transport mechanism, and a respective second physical interface of the inter-chiplet communication resources, each respective second binding differing from the respective first binding in at least one of the bus protocol, the transport mechanism, or the physical interface.

9. The chiplet system of claim 8, wherein at least two architectural inter-chiplet channels of the plurality of architectural inter-chiplet channels share a common first physical interface.

10. The chiplet system of claim 8, wherein the plurality of architectural inter-chiplet channels comprises at least one of a Boot Channel, a System Management Channel, a Security Channel, an Interrupt Channel, a Cross Trigger Channel, a Serial Test Channel, and a Functional Safety Messaging Channel.

11. The chiplet system of claim 7, wherein the channel abstraction circuitry comprises hardware control logic configured to:
monitor the availability condition of the inter-chiplet communication resources; and
switch, based on the availability condition, the architectural inter-chiplet channel from the selected binding to the other binding of the first binding and the second binding.

12. The chiplet system of claim 11, wherein the hardware control logic comprises a state machine in a system interface of at least one of the plurality of chiplets and is configured to automatically switch the architectural inter-chiplet channel from the selected binding to the other binding based on a hardware-detected change in availability of the first physical interface or the second physical interface.

13. The chiplet system of claim 12, wherein the hardware-detected change in availability corresponds to an establishment of a high-speed die-to-die connection in the chiplet system.

14. The chiplet system of claim 7, wherein the channel abstraction circuitry is configured to switch the architectural inter-chiplet channel from the selected binding to the other binding of the first binding and the second binding based on a software command.

15. The chiplet system of claim 7, wherein:
each chiplet in the plurality of chiplets houses an instance of the channel abstraction circuitry; and
for each chiplet, the first physical interface and the second physical interface of the corresponding instance of the channel abstraction circuitry refer to physical interfaces of the respective chiplet.

16. The chiplet system of claim 7, wherein the availability condition is derived from an operation state of the chiplet system.

17. A network of chiplets comprising:
a first chiplet;
a second chiplet;
a first physical interface of the first chiplet and a corresponding first physical interface of the second chiplet that provide a first die-to-die connection between the first chiplet and the second chiplet; and
a second physical interface of the first chiplet and a corresponding second physical interface of the second chiplet that provide a second die-to-die connection between the first chiplet and the second chiplet;
wherein the first chiplet and the second chiplet support an architectural channel of a system layer associated with a functional domain, and wherein the first chiplet comprises a system interface configured to:
maintain a first mapping of the architectural channel to a first bus protocol, a first transport scheme, and the first die-to-die connection;
maintain a second mapping of the architectural channel to a second bus protocol, a second transport scheme, and the second die-to-die connection;
determine, during runtime, that the first mapping is available for communication of traffic of the architectural channel between the first chiplet and the second chiplet;
route the traffic of the architectural channel through the first die-to-die connection;
determine, during runtime and after routing the traffic through the first die-to-die connection, that the second mapping is available for communication of traffic of the architectural channel between the first chiplet and the second chiplet; and
rerouting, during runtime, the traffic of the architectural channel to the second mapping based on the determination that the second mapping is available.

18. The network of claim 17, wherein:
the architectural channel is a Boot Channel;
the first bus protocol is Open Chiplet Configuration Protocol; and
the second die-to-die connection is a high-speed die-to-die connection.

19. The network of claim 17, wherein:
the architectural channel is a System Management Channel;
the first bus protocol is Open Chiplet Configuration Protocol;
the second bus protocol is a noncoherent protocol; and
the second die-to-die connection is a high-speed die-to-die connection.

20. The network of claim 17, wherein:
the architectural channel is a Security Channel;
the first bus protocol is Open Chiplet Configuration Protocol;
the second bus protocol is a noncoherent protocol; and
the second die-to-die connection is a high-speed die-to-die connection.
